(19) United States
(12) Patent Application Publication
(10) Pub. No.: US 2008/0030188 A1
(43) Pub. Date: Feb. 7, 2008

(54) Non-contact position sensor

(76) Inventors: Richard Louis Ponziani, Centerville, OH (US); William Robert Jesse, Beavercreek, OH (US)

Correspondence Address: STEVENS & SHOWALTER LLP, 7019 CORPORATE WAY, DAYTON, OH, 45459-4238, US

(21) Appl. No.: 11/500,150

(22) Filed: Aug. 7, 2006

(51) Int. Cl. G01B 7/30

(52) U.S. Cl. 324/207.2

(57) ABSTRACT

A position sensor is provided for determining the position of a movable member. The position sensor includes a sensor providing an analog output voltage in response to a sensed magnetic field, a magnet located adjacent and in spaced relation to the sensor, and a magnetic field varying member attached to the movable member. The magnetic field varying member includes an outer edge extending to a location axially positioned between the sensor and the magnet, and the magnetic field varying member is movable to vary a magnetic flux between the magnet and the sensor in response to movement of the movable member.

### BACKGROUND OF THE INVENTION

1. Field of the Invention

The present invention relates generally to a position sensing device and, more particularly, to a position sensing device using a sensed magnetic field to identify a corresponding position of a movable member.

2. Description of the Prior Art

Position sensors are used for detecting positions of machines or machine components in a wide array of applications and generally provide position information on the relative position of a movable element, such as a rotating shaft, relative to another element. Such position sensors have been used as absolute encoders for actuators and have been used in torque sensing applications where a torque may be determined based on the relative movement of two components connected by a torsional member.

U.S. Pat. No. 6,305,234 discloses an absolute encoder including a transducer element that may be a permanent magnet formed with a profile that varies with location on the transducer element. Movement of the transducer element, such as a magnet, relative to a sensor may vary the strength of the magnetic field measuring by the sensor, and in particular, the measured magnetic field may vary as a result of the profile of the transducer element varying the distance between the surface of the transducer element and the sensor. Accordingly, a relatively large permanent magnet component, defining the transducer element, is necessary to provide a magnetic field throughout the travel of the transducer element relative to the sensor.

U.S. Pat. No. 6,211,794 discloses an analog rotary position sensor including a spiral bipolar magnetic track supported for rotation with movement of a movable member. Rotation of the magnetic track causes a sensor adjacent the magnetic track to provide an analog output that is proportional to the position of the movable member. Accordingly, the disclosed rotary position sensor requires a magnet having a rotational extent corresponding to the extent of travel of the movable member.

US Patent Application Publication No. 2003/0062215 discloses a torque sensor that senses relative movement between input and output shafts of a steering shaft. The torque sensor includes a permanent magnet supported on the input shaft and a magnetic body supported on the output shaft. The permanent magnet is disclosed as a substantial cylindrical member comprising S poles and N poles alternately arranged in a circumferential direction. The input and output shafts and associated magnet and magnetic body are rotatable relative to a Hall IC. Relative rotation between the input and output shafts causes the magnetic body to move relative to the permanent magnet to a cause a change in the magnetic flux sensed by the Hall IC.

The above described known sensor structures for determining the rotational position of a rotating member relative to another member have either comprised a relatively large magnet that forms a transducer or comprised a relatively large magnet operating in combination with a transducer element to cause a magnetic field sensor to output a signal corresponding to the rotational position of the rotating member. Generally, the cost of a magnet increases with the size of the magnet, such that is it desirable to provide a sensor structure that incorporates a relatively small magnet to minimize the cost of the sensor structure.

### SUMMARY OF THE INVENTION

In accordance with one aspect of the invention, a position sensor is provided for determining the position of a movable member. The position sensor comprises a sensor providing an analog output voltage in response to a sensed magnetic field, a magnet located adjacent and in spaced relation to the sensor, and a magnetic field varying member attached to the movable member and positioned in a magnetic field of the magnet. The magnetic field varying member is movable to vary a magnetic flux between the magnet and the sensor in response to movement of the movable member.

In accordance with another aspect of the invention, a position sensor is provided for determining the position of a movable member. The position sensor comprises a sensor providing an analog output voltage in response to a sensed magnetic field, a magnet located adjacent and in spaced relation to the sensor, and a magnetic field varying member attached to the movable member. The magnetic field varying member includes an outer edge extending to a location axially positioned between the sensor and the magnet, and the magnetic field varying member is movable to vary a magnetic flux between the magnet and the sensor in response to movement of the movable member.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a side elevation view of a motor actuator incorporating a position sensor in accordance with the present invention;

FIG. 2 is an enlarged view of a portion of FIG. 1 including the position sensor;

FIG. 3 is a graph of the voltage output of the position sensor;

FIG. 4 is an end view of the motor actuator of FIG. 1 further illustrating the position sensor;

FIG. 5 is an end view similar to FIG. 4 showing a second embodiment of the invention including a linearly movable magnetic field varying member; and

FIG. 6 is a side view of a third embodiment of the invention showing a variation on the linearly movable magnetic field varying member.

### DETAILED DESCRIPTION OF THE INVENTION

The present invention relates to a position sensing device for providing an absolute position sensing function to a system, such as by providing an output corresponding to a position of a rotating shaft.

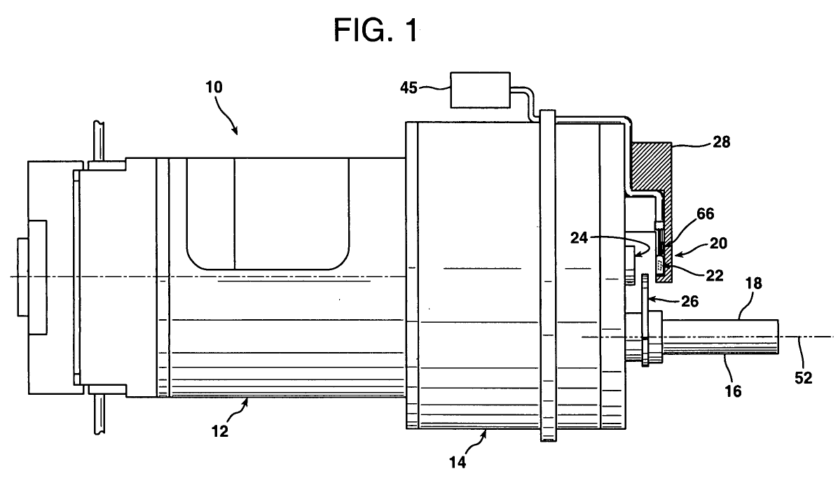

Referring to FIG. 1, the position sensor of the present invention may be incorporated into an actuator apparatus, such as a motor driven actuator 10, that may be used for positionally locating an articulated element of an actuated member (not shown). The actuator 10 may include a motor 12, for example a brushless motor, and a transmission 14, such as a gear reduction transmission. The transmission provides an output through an output shaft 16 which may include a flat 18 (see also FIG. 3) for non-rotatably engaging with an input element to drive the articulated element of the actuated member (not shown).

In many applications, it is desirable to position a driven input element to a generally precise predetermined position without referencing the end position of the driven input element to an initial or starting position. For example, it may be desirable to rotate the output shaft 16 to predetermined positions without monitoring the rotational movement of either the motor 12 or the transmission 14 relative to a starting position. In accordance with an embodiment of the present invention, position information may be provided by a position sensor 20 located adjacent the output shaft 16.

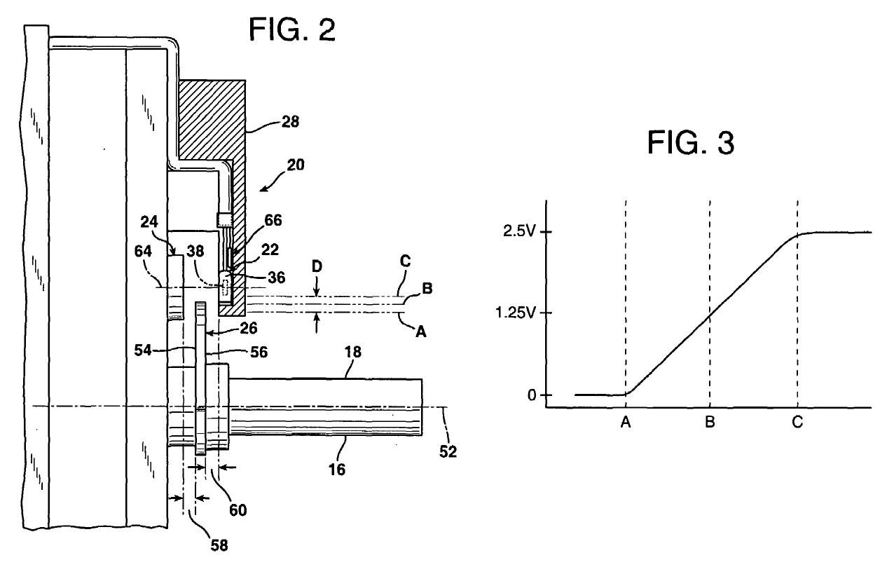

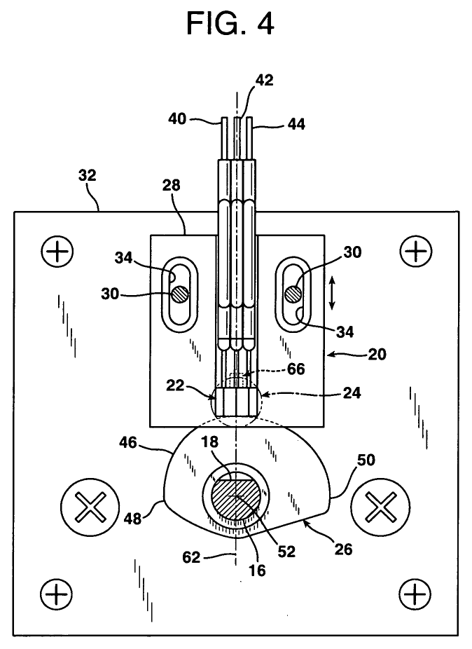

Referring to FIGS. 2 and 4, the position sensor 20 generally comprises a Hall sensor 22, a magnet 24, and a magnetic field varying member, illustrated herein as a generally planar or plate-like disc 26. The Hall sensor 22 is mounted to an adjustment block 28 supported by fasteners 30 (FIG. 4) to a transmission housing 32. The fasteners 30 extend through slots 34 in the adjustment block 28 to clamp the adjustment block 28 into a desired position on the transmission housing 32, as will be described further below.

The Hall sensor 22 preferably comprises a ratiometric linear Hall effect sensor, such as a sensor model A1321 available from Allegro Microsystems, Inc. of Worcester, Mass. The Hall sensor 22 comprises a housing 36 (FIG. 2) enclosing a circuit incorporating a Hall element 38 for sensing a magnetic field produced by the magnet 24. The housing 36 may comprise a generally rectangular frontal area dimensioned approximately 0.164 in. (4.17 mm) by 0.122 in. (3.10 mm), and the Hall element 38 may comprise a relatively small component within the housing 36 and having a frontal area dimensioned approximately 0.02 in. (0.5 mm) by 0.02 in. (0.5 mm). The Hall sensor 22 includes leads 40, 42, 44 for input voltage, ground and a signal or voltage output, respectively. The output from the Hall sensor 22 comprises a voltage output that comprises a measurement proportional to the magnetic flux density at the Hall element 38 and, in the present embodiment, the output may vary from 2.5V to 0V. The leads may be connected to a controller 45 that may include a microprocessor operating to monitor or determine the output of the Hall sensor 22 in relation to a position of the disc 26.

The magnet 24 may be supported on the transmission housing 32, and preferably comprises a magnet producing a strong magnetic field, such as a rare earth magnet, where a single, relatively small magnet may produce a sufficiently strong magnetic field to be sensed by the Hall sensor 22. Specifically, in the present embodiment, the magnet 24 may comprise a samarium cobalt magnet formed with a disc-shaped configuration having a diameter of approximately 0.25 in. (6.35 mm), and with one pole of the magnet 24 positioned adjacent the transmission housing 32 and the other pole facing towards the Hall sensor 22. As seen in FIG. 2, the magnet 24 and Hall sensor 22 are preferably positioned along a line 64 that is generally parallel to a rotational axis 52 of the output shaft 16, such that the center of the magnet 24 may be substantially aligned with the Hall element 38, although precise dimensional alignment between the magnet 24 and the Hall element 38 is not required and, as will be described further below, may be subject to adjustment to obtain a desired functional output during operation of the position sensor 20.

Referring to FIG. 4, the plate-like disc 26 forming the magnetic field varying member is rigidly mounted to the output shaft 16 for rotation with the output shaft 16. The disc 26 is positioned on the output shaft 16 at a location that is axially between the magnet 24 and the Hall sensor 22, FIG. 2. The disc 26 in the illustrated embodiment includes a peripheral outer edge 46 which spans a circumferential extent of at least approximately 180° about the rotational axis 52 of the shaft 16 between opposing first and second edge portions 48, 50 of the disc 26. The outer edge 46 defines an outwardly progressing spiral or ramp from the first edge portion 48 to the second edge portion 50, such that the radial distance of the outer edge 46 from the rotational axis 52 increases substantially continuously as the outer edge 46 progresses from the first edge portion 48 to the second edge portion 50. The disc 26 is preferably formed of a magnetically soft material, such as a magnetically soft alloy, for affecting the magnetic field of the magnet 24. That is, the disc 26 may be formed of a material which is capable of being magnetized upon application of an external magnetic field, but which returns to a nonmagnetic condition when the field is removed. For example, the disc 26 may be formed of a ferrous material, such as 1010 or 1018 steel, having a thickness in the range of 0.020-0.060 in. (0.5-1.5 mm), and is preferably approximately 0.040 in. (1.0 mm) thick.

As seen in FIG. 2, the disc 26 includes opposing faces 54, 56 located in axially facing relationship to the magnet 24 and the Hall sensor 22, respectively. A gap 58 is defined between the disc face 54 and the magnet 24, and a gap 60 is defined between the disc face 56 and the Hall sensor 22. The size of the gaps 58, 60 is on the order of 0.020-0.080 in. (0.5-2.0 mm), and each of the gaps 58, 60 is preferably approximately 0.050 in. (1.3 mm)

As the disc 26 rotates with the output shaft 16, the outer edge 46 moves into or out of the magnetic field extending between the magnet 24 and the Hall element 38 of the Hall sensor 22. Lines A, B and C in FIG. 2 illustrate three radial locations of the outer edge 46 of the disc 26 corresponding to three rotational positions of the disc 26. Specifically, the lines A, B, C identify locations of the outer edge 46 where the outer edge 46 intersects a line 62 (FIG. 4) extending through the rotational axis 52 and through the line 64 (FIG. 2) extending through the magnet 24 and the Hall element 38. Line A illustrates the radial position of the outer edge 46 along the line 64 when the disc 26 is rotated to a 180° position, line B illustrates the radial position of the outer edge 46 when the disc 26 is rotated to a 90° position, and line C illustrates the radial position of the outer edge 46 when the disc 26 is rotated to a 0°. In the described embodiment, the position illustrated by line A corresponds to a portion of the outer edge 46, i.e., the first edge portion 48, being displaced to a location furthest from the magnetic field; and the position illustrated by line C corresponds to a portion of the outer edge 46, i.e., the second edge portion 50, being displaced to a location closest to the magnetic field. The variation in the radial position of the outer edge 46, as measured by the distance, D, between lines A and C is approximately 0.100 in. (2.54 mm).

FIG. 3 illustrates the variation in the output from the Hall sensor 22, as produced at the output lead 44, where a continuous analog voltage output will be produced during rotation of the disc 26 through 180° of movement of the output shaft 16. It can be seen that the output may vary from approximately 0V when the outer edge 46 of the disc 26 is rotated to the position corresponding to line A, to a maximum of approximately 2.5V when the outer edge 46 of the disc 26 is rotated to the position corresponding to line C. The output produced at the output lead 44 is substantially linear, in proportion to rotation of the disc 26, such that the output when the outer edge 46 of the disc 26 is rotated to the position corresponding to line B will be approximately 1.25V.

It should be understood that the described outputs from the Hall sensor 22 for the present embodiment are for illustrative purposes and that other voltage outputs may be provided while providing a position sensor 20 in accordance with the principals described above. Also, the disc 26 may be configured to indicate a range of rotational positions of less than or greater than 180°. In addition, the outer edge 46 of the disc 26 may be provided with other configurations than a smoothly varying spiral or ramp, such as a step wise varying configuration or a combination of steps and ramps.

Referring to FIG. 4, the adjustment block 28 is preferably adjustable in a direction substantially parallel to the line 62, where the slots 34 may be located to a desired position relative to the fasteners 30. The positioning of the adjustment block 28 may be performed with the disc 26 rotated to the 90° position, i.e., the position aligning the outer edge 46 to the location of line B in FIG. 2, and the block 28 may be slidably moved along the fasteners 30 to locate the Hall sensor 22 in a position where the output is 1.25V. Thus, the output of the Hall sensor 22 is calibrated with reference to the mid-point of its desired operating range.

It may be noted that the outer edge 46 of the disc 26 need not intersect a line extending between the Hall element 38 and the magnet 24, e.g., the imaginary line 64 extending generally through the center of the magnet 24, in order to affect the magnetic field, changing the measured magnetic flux, sufficiently to identify the rotational position of the disc 26. That is, since the lines of magnetic flux follow curved lines extending from one pole of the magnet 24 to the opposite pole, and passing through the Hall element 38, the outer edge 46 generally may be positioned to a variety of locations not directly aligned between the magnet 24 and the Hall element 38 to affect the magnetic field sensed by the Hall sensor 22. Also, a relatively small variation in displacement of the disc 26 within the magnetic field is sufficient to provide a measurable output for identifying an absolute rotational position of the disc 26. It may be noted that in accordance with the presently described embodiment, the Hall sensor 22 may detect a rotational displacement of less than 0.3°.

During normal operating conditions, the supply voltage through the lead 40 to the Hall sensor 22 may vary, resulting in a variation in the signal or output voltage provided to the lead 44. In order to maintain a consistent output for any given rotational position of the disc 26, the controller 45 may monitor the voltage provided as a power input to the Hall sensor 22 and compensate or adjust the output voltage received from the Hall sensor 22 with reference to the supply voltage.

The magnetic flux of a rare earth magnet may vary with temperature. The Hall sensor 22 is preferably selected such that it is temperature matched to the particular magnet 24 used in the position sensor 20, such as a Hall sensor 22 that is temperature matched to a samarium cobalt magnet 24. That is, control circuitry in the Hall sensor 22 controls the output of the Hall sensor 22 to compensate for magnetic flux variations from the magnet 24 resulting from changes in the ambient temperature as well as to compensate for any temperature influenced variations occurring within the components of the Hall sensor 22. Alternatively, a separate temperature sensor, such as a thermistor 66, may be located closely adjacent to the Hall sensor 22 for detecting an ambient temperature in the sensing area of the Hall sensor 22 and the magnet 24. An output of the thermistor 66 may be provided to the controller 45 to adjust the sensed output of the Hall sensor 22 to compensate for ambient temperature variations. For example, a table of temperature compensating factors may be stored in the controller 45 for adjusting the received output signal from the Hall sensor 22 with reference to the temperature. The table may be empirically derived for a particular magnet 24 and Hall sensor 22 combination to provide a consistent predetermined output value for each position of the disc 26 regardless of the ambient temperature. It should be understood that other temperature sensors may be used including, without limitation, a thermocouple for providing a temperature signal to the controller 45.

In addition to the above described aspects, the position sensor 20 described herein provides a non-contact sensor for determining the position of a movable member, such as a rotating shaft 16. Further, the position sensor 20 operates as an absolute encoder which may be calibrated once, and which will convey accurate position information, based on the strength of the magnetic field at the Hall sensor 22, without requiring recalibration during subsequent use of the position sensor 20 if power to the position sensor 20 is discontinued following the calibration operation.

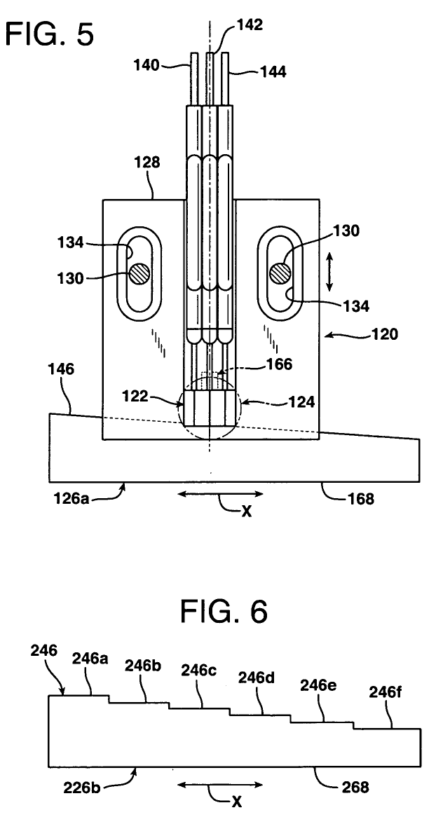

Referring to FIG. 5, an alternative second embodiment of the invention is illustrated where elements corresponding to elements of the first described embodiment are labeled with the same reference numeral increased by 100. The second embodiment comprises a position sensor 120 including a magnet 124 and a Hall sensor 122, where the Hall sensor 122 is mounted to an adjustment block 128 for movement relative to the magnet 124 to calibrate the position sensor 120. A magnetic field varying member 126a is located between the magnet 124 and the Hall sensor 122. The magnetic field varying member 126a comprises an elongate member that is movable in a linear direction X, and includes an outer edge 146 that is formed as a ramp surface defining a varying distance relative to a line extending parallel to the direction X of travel of the magnetic field varying member 126a, i.e., relative to a linear bottom edge 168. The ramp surface of the outer edge 146 in the present embodiment is illustrated as a smoothly varying surface. The magnetic field varying member 126a is formed of a magnetically soft material, and may be connected to a linearly movable member, where movement of the movable member will cause the outer edge 146 to move within the magnetic field between the magnet 124 and the Hall sensor 122 to vary the magnetic flux sensed by the Hall sensor 122, depending on the linear position of the outer edge 146 in the direction X.

Referring to FIG. 6, an alternative third embodiment of a magnetic field varying member 226b is illustrated, and comprises linearly movable magnetic field varying member 226b for use in a manner similar to that described for the second embodiment of FIG. 5. The magnetic field varying member 226b comprises an outer surface 246 formed as a ramp surface extending toward a bottom edge 268 in segments, shown as stepwise decreasing sectors 246a, 246b, 246c, 246d, 246e, 246f. The sectors 246a, 246b, 246c, 246d, 246e, 246f permit distinct segments of linear movement to be identified during actuation of the magnetic field varying member in the linear direction X.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A position sensor for determining the position of a movable member, said position sensor comprising:
a sensor providing an analog output voltage in response to a sensed magnetic field;
a magnet located adjacent and in spaced relation to said sensor; and
a magnetic field varying member attached to said movable member and positioned in a magnetic field of said magnet, and said magnetic field varying member is movable to vary a magnetic flux between said magnet and said sensor in response to movement of said movable member.

2. The apparatus of claim 1, wherein said magnet is stationary relative to said sensor and said magnetic field varying member moves relative to said sensor and said magnet to vary said magnetic flux.

3. The apparatus of claim 1, wherein said sensor generates said analog voltage output in proportion to said magnetic flux.

4. The apparatus of claim 1, wherein said sensor comprises a linear Hall sensor.

5. The apparatus of claim 4, wherein an output from said Hall sensor is adjusted with reference to an input voltage supplied to said Hall sensor to provide a magnetic flux measurement.

6. The apparatus of claim 4, wherein an output of said Hall sensor is adjusted with reference to an ambient temperature to provide a magnetic flux measurement.

7. The apparatus of claim 1, wherein said magnetic field varying member comprises a magnetically soft member that varies the magnetic flux received by said sensor in a predetermined manner in relation to movement of said movable member.

8. The apparatus of claim 7, wherein said outer edge of said magnetic field varying member is positioned at an axial location that is between said magnet and said sensor.

9. The apparatus of claim 8, wherein an outer edge of said magnetic field varying member is located a predetermined distance from a line extending between said magnet and said sensor, and said predetermined distance varies with movement of said movable member.

10. The apparatus of claim 9, wherein said magnetic field varying member is rotatable about a rotational axis, and said outer edge comprises a peripheral edge defining a varying radial distance from said rotational axis, and rotation of said magnetic field varying member about said rotational axis causes said outer edge to be displaced relative to said sensor and said magnet in a direction perpendicular to said rotational axis.

11. The apparatus of claim 9, wherein said magnetic field varying member is linearly movable, and said outer edge comprises a ramp edge defining a varying distance relative to a line extending parallel to the direction of travel of the magnetic field varying member.

12. The apparatus of claim 11, wherein the ramp edge is formed with discrete steps extending along the length of said magnetic field varying member.

13. A position sensor for determining the position of a movable member, said position sensor comprising:
a sensor providing an analog output voltage in response to a sensed magnetic field;
a magnet located adjacent and in spaced relation to said sensor; and
a magnetic field varying member attached to said movable member, said magnetic field varying member including an outer edge extending to a location axially positioned between said sensor and said magnet, and said magnetic field varying member is movable to vary a magnetic flux between said magnet and said sensor in response to movement of said movable member.

14. The apparatus of claim 13, wherein said magnetic field varying member is located in spaced relation to said sensor and said magnet.

15. The apparatus of claim 13, wherein said magnet is located in fixed relation to said sensor.

16. The apparatus of claim 13, wherein said sensor generates said analog voltage output in proportion to said magnetic flux.

17. The apparatus of claim 16, wherein said sensor comprises a linear Hall sensor.

18. The apparatus of claim 17, wherein an output from said Hall sensor is adjusted with reference to an input voltage supplied to said Hall sensor to provide a magnetic flux measurement.

19. The apparatus of claim 17, wherein an output of said Hall sensor is adjusted with reference to an ambient temperature to provide a magnetic flux measurement.

20. The apparatus of claim 13, wherein said magnetic field varying member comprises a magnetically soft member that varies the magnetic flux received by said sensor in a predetermined manner in relation to movement of said movable member.

21. The apparatus of claim 20, wherein said movable member is rotatable and said magnetic field varying member is movable relative to said sensor and said magnet in response to rotation of said rotatable member.

22. The apparatus of claim 21, wherein said magnetic field varying member comprises a substantially solid disc, and said outer edge comprises an outer peripheral edge of said disc.

23. The apparatus of claim 22, wherein said outer edge defines a varying radial distance from said rotational axis, and rotation of said disc about said rotational axis causes said outer edge to be displaced relative to said sensor and said magnet in a direction perpendicular to said rotational axis.

24. The apparatus of claim 23, wherein said outer edge comprises a generally continuous spiral.

25. The apparatus of claim 13, wherein said magnetic field varying member is linearly movable, and said outer edge comprises a ramp edge defining a varying distance relative to a line extending parallel to the direction of travel of the magnetic field varying member.

26. The apparatus of claim 25, wherein the ramp edge is formed with discrete steps extending along the length of said magnetic field varying member.
